(19) United States
(12) Patent Application Publication
(10) Pub. No.: US 2019/0061617 A1
(43) Pub. Date: Feb. 28, 2019

(54) Audio Control Systems And Methods Based On Driver Helmet Use

(71) Applicant: GM Global Technology Operations LLC, Detroit, MI (US)

(72) Inventors: Branton E. DENNIS, IV, Howell, MI (US); Roger C. BARLOW, JR., Brighton, MI (US); Scott M. REILLY, Southfield, MI (US)

(21) Appl. No.: 15/689,445

(22) Filed: Aug. 29, 2017

(51) Int. Cl. B60Q 9/00

(52) U.S. Cl. CPC B60Q 9/00; B60Y 2400/303; B60Y 2400/3015; B60Y 2400/3017

(57) ABSTRACT

An audio control system of a vehicle includes a sound control module configured to determine N magnitudes for outputting a predetermined sound at N predetermined harmonics of a base frequency, respectively. N is an integer greater than one. An adjustment module is configured to determine N magnitude adjustments for the N predetermined harmonics, respectively, based on a helmet worn by a driver of the vehicle. The sound control module is further configured to determine N adjusted magnitudes for the N predetermined harmonics based on: the N magnitudes for the N predetermined harmonics, respectively; and the N magnitude adjustments for the N predetermined harmonics, respectively. An audio driver module is configured to, based on the N adjusted magnitudes, apply power to at least one speaker of the vehicle and output the predetermined sound at the N predetermined harmonics of the base frequency, respectively.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to audio systems of vehicles and more particularly to systems and methods for outputting sound via audio systems of vehicles based on whether a driver is wearing a helmet.

Some vehicles include conventional powertrains having an internal combustion engine and a drivetrain that normally emit sounds during vehicle operation. Many consumers have come to rely on these normal sounds as a sign of proper vehicle function. Changes in these normal sounds may indicate, to certain consumers, that the internal combustion engine and/or the drivetrain may be functioning differently than expected.

Some consumers may have expectations as to what the normal sounds of different types of vehicle should be. For example, a consumer may expect certain sounds from “high performance” vehicles, while some sounds may not be expected from other types of vehicles. An absence of expected sounds may detract from a user's enjoyment of a vehicle. Presence of unexpected vehicle sounds, such as sound produced by one or more powertrain components, may also detract from a user's enjoyment of a vehicle.

### SUMMARY

In a feature, an audio control system of a vehicle is described. A sound control module is configured to determine N magnitudes for outputting a predetermined sound at N predetermined harmonics of a base frequency, respectively. N is an integer greater than one. An adjustment module is configured to determine N magnitude adjustments for the N predetermined harmonics, respectively, based on a helmet worn by a driver of the vehicle. The sound control module is further configured to determine N adjusted magnitudes for the N predetermined harmonics based on: the N magnitudes for the N predetermined harmonics, respectively; and the N magnitude adjustments for the N predetermined harmonics, respectively. An audio driver module is configured to, based on the N adjusted magnitudes, apply power to at least one speaker of the vehicle and output the predetermined sound at the N predetermined harmonics of the base frequency, respectively.

In further features, the adjustment module is configured to: when the helmet worn by the driver is a closed faced helmet, set the N magnitude adjustments for the N predetermined harmonics to a first set of N predetermined magnitude adjustments for the N predetermined harmonics calibrated for closed faced helmets; and when the helmet worn by the driver is an open faced helmet, set the N magnitude adjustments for the N predetermined harmonics to a first set of N predetermined magnitude adjustments for the N predetermined harmonics calibrated for open faced helmets.

In further features, a helmet module is configured to, based on images captured using a driver facing camera within a passenger cabin of the vehicle, indicate that the helmet worn by the driver is one of: an open face helmet and a closed face helmet.

In further features, a track module is configured to indicate whether the vehicle is in a track mode, and the adjustment module is configured to determine the N magnitude adjustments based on the helmet worn by the driver when the vehicle is in the track mode.

In further features, the adjustment module is configured to set the N magnitude adjustments to a predetermined value when the vehicle is not in the track mode. Based on the N magnitude adjustments being set to the predetermined value, the sound control module is configured to set the N adjusted magnitudes for the N predetermined harmonics equal to the N magnitudes for the N predetermined harmonics, respectively.

In further features, the track module is configured to determine whether the vehicle is in the track mode based on a vehicle speed and a lateral acceleration of the vehicle.

In further features, the adjustment module is configured to set the N magnitude adjustments to a predetermined value when the driver is not wearing a helmet. Based on the N magnitude adjustments being set to the predetermined value, the sound control module is configured to set the N adjusted magnitudes for the N predetermined harmonics equal to the N magnitudes for the N predetermined harmonics, respectively.

In further features, the sound control module is configured to determine the N magnitudes based on a torque output of an engine of the vehicle.

In further features, the adjustment module is configured to: when the helmet worn by the driver is a first type of helmet, set the N magnitude adjustments for the N predetermined harmonics to a first set of N predetermined magnitude adjustments for the N predetermined harmonics calibrated for the first type of helmet; and when the helmet worn by the driver is a second type of helmet, set the N magnitude adjustments for the N predetermined harmonics to a first set of N predetermined magnitude adjustments for the N predetermined harmonics calibrated for the second type of helmet.

In further features: the first type of helmet is a first model of helmet; and the second type of helmet is a second model of helmet.

In further features, a helmet module is configured to indicate a type of the helmet worn by the driver based on at least one image captured using a driver facing camera within a passenger cabin of the vehicle.

In further features, a helmet module is configured to indicate a type of the helmet worn by the driver based on signals from at least one of: a radar sensor within a passenger cabin of the vehicle; a sonar sensor within the passenger cabin of the vehicle; a light detection and ranging (LIDAR) sensor within the passenger cabin of the vehicle; and a radio frequency identification (RFID) transceiver within the passenger cabin of the vehicle.

In further features, a profile module is configured to indicate a type of the helmet worn by the driver based on user input signals indicative of the type of helmet worn by the driver.

In further features, the sound control module is configured to set the N adjusted magnitudes for the N predetermined harmonics based on sums of: the N magnitudes for the N predetermined harmonics, respectively; and the N magnitude adjustments for the N predetermined harmonics, respectively.

In further features, the sound control module is configured to set the N adjusted magnitudes for the N predetermined harmonics based on mathematical products of: the N magnitudes for the N predetermined harmonics, respectively; and the N magnitude adjustments for the N predetermined harmonics, respectively.

In further features, the base frequency is a predetermined fundamental frequency of an engine.

In further features, the base frequency corresponds to a rotational speed of an engine.

In further features, the base frequency does not correspond to a rotational speed of an engine and is not a predetermined fundamental frequency of the engine.

In a feature, an audio control method for a vehicle includes: determining N magnitudes for outputting a predetermined sound at N predetermined harmonics of a base frequency, respectively, N being an integer greater than one; determining N magnitude adjustments for the N predetermined harmonics, respectively, based on a helmet worn by a driver of the vehicle; determining N adjusted magnitudes for the N predetermined harmonics based on: the N magnitudes for the N predetermined harmonics, respectively; and the N magnitude adjustments for the N predetermined harmonics, respectively; and based on the N adjusted magnitudes, applying power to at least one speaker of the vehicle and outputting the predetermined sound at the N predetermined harmonics of the base frequency, respectively.

In further features, determining the N magnitude adjustments for the N predetermined harmonics, respectively, includes: when the helmet worn by the driver is a first type of helmet, setting the N magnitude adjustments for the N predetermined harmonics to a first set of N predetermined magnitude adjustments for the N predetermined harmonics calibrated for the first type of helmet; and when the helmet worn by the driver is a second type of helmet, setting the N magnitude adjustments for the N predetermined harmonics to a first set of N predetermined magnitude adjustments for the N predetermined harmonics calibrated for the second type of helmet.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram including an example powertrain system of a vehicle including an engine;

FIG. 2 is a functional block diagram including an example audio control module and speakers;

FIG. 3 is a flowchart depicting an example method of controlling sound output based on use of a helmet by a driver.

In the drawings, reference numbers may be reused to identify similar and/or identical elements.

### DETAILED DESCRIPTION

Internal combustion engines of vehicles combust air and fuel within cylinders. An engine control module (ECM) controls engine actuators, for example, based on a driver torque request. A vehicle may also include one or more motor generator units (MGUs) that can be used to perform different functions at different times. For example, an MGU can be used (i) to output torque to a powertrain of the vehicle and (ii) to impose a load on the powertrain of the vehicle to convert mechanical energy into electrical energy, for example, for regeneration.

An audio control module outputs engine sound via one or more speakers of the vehicle. More specifically, the audio control module sets frequencies and magnitudes for outputting a sound based on at least one of engine speed and engine torque.

Some drivers may wear a helmet or other ear protection while driving. For example, a driver may wear a helmet while driving a vehicle at a track. A helmet, however, may alter sound heard by the driver. According to the present disclosure, the audio control module adjusts sound output based on a helmet worn by a driver. In this manner, a driver wearing a helmet will have the same or a similar aural experience as a driver not wearing a helmet.

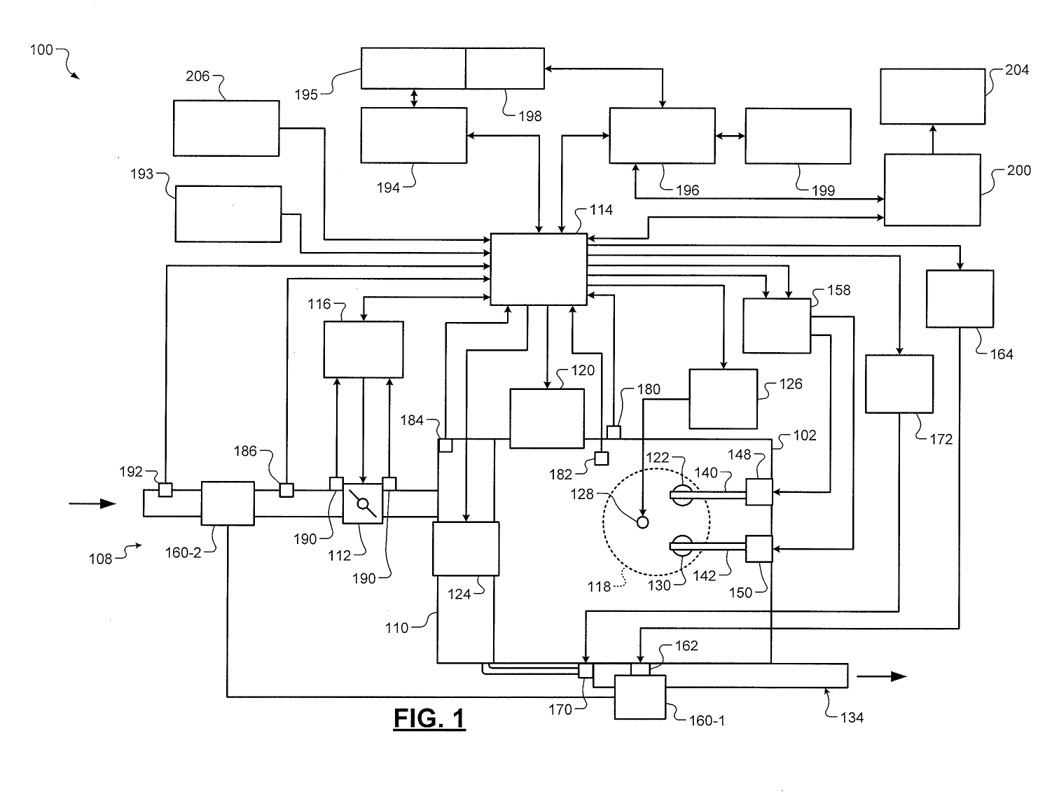

Referring now to FIG. 1, a functional block diagram of an example powertrain system 100 is presented. The powertrain system 100 of a vehicle includes an engine 102 that combusts an air/fuel mixture to produce torque. The vehicle may be non-autonomous or autonomous.

Air is drawn into the engine 102 through an intake system 108. The intake system 108 may include an intake manifold 110 and a throttle valve 112. For example only, the throttle valve 112 may include a butterfly valve having a rotatable blade. An engine control module (ECM) 114 controls a throttle actuator module 116, and the throttle actuator module 116 regulates opening of the throttle valve 112 to control airflow into the intake manifold 110.

Air from the intake manifold 110 is drawn into cylinders of the engine 102. While the engine 102 includes multiple cylinders, for illustration purposes a single representative cylinder 118 is shown. For example only, the engine 102 may include 2, 3, 4, 5, 6, 8, 10, and/or 12 cylinders. The ECM 114 may instruct a cylinder actuator module 120 to selectively deactivate some of the cylinders under some circumstances, as discussed further below, which may improve fuel efficiency.

The engine 102 may operate using a four-stroke cycle or another suitable engine cycle. The four strokes of a four-stroke cycle, described below, will be referred to as the intake stroke, the compression stroke, the combustion stroke, and the exhaust stroke. During each revolution of a crankshaft (not shown), two of the four strokes occur within the cylinder 118. Therefore, two crankshaft revolutions are necessary for the cylinder 118 to experience all four of the strokes. For four-stroke engines, one engine cycle may correspond to two crankshaft revolutions.

When the cylinder 118 is activated, air from the intake manifold 110 is drawn into the cylinder 118 through an intake valve 122 during the intake stroke. The ECM 114 controls a fuel actuator module 124, which regulates fuel injection to achieve a desired air/fuel ratio. Fuel may be injected into the intake manifold 110 at a central location or at multiple locations, such as near the intake valve 122 of each of the cylinders. In various implementations (not shown), fuel may be injected directly into the cylinders or into mixing chambers/ports associated with the cylinders. The fuel actuator module 124 may halt injection of fuel to cylinders that are deactivated.

The injected fuel mixes with air and creates an air/fuel mixture in the cylinder 118. During the compression stroke, a piston (not shown) within the cylinder 118 compresses the air/fuel mixture within the cylinder 118. The engine 102 may be a compression-ignition engine, in which case compression causes ignition of the air/fuel mixture. Alternatively, the engine 102 may be a spark-ignition engine, in which case a spark actuator module 126 energizes a spark plug 128 in the cylinder 118 based on a signal from the ECM 114, which ignites the air/fuel mixture. Some types of engines, such as homogenous charge compression ignition (HCCI) engines may perform both compression ignition and spark ignition. The timing of the spark may be specified relative to the time when the piston is at its topmost position, which will be referred to as top dead center (TDC).

The spark actuator module 126 may be controlled by a timing signal specifying how far before or after TDC to generate the spark. Because piston position is directly related to crankshaft rotation, operation of the spark actuator module 126 may be synchronized with the position of the crankshaft. The spark actuator module 126 may disable provision of spark to deactivated cylinders or provide spark to deactivated cylinders.

During the combustion stroke, the combustion of the air/fuel mixture drives the piston down, thereby driving the crankshaft. The combustion stroke may be defined as the time between the piston reaching TDC and the time when the piston returns to a bottom most position, which will be referred to as bottom dead center (BDC).

During the exhaust stroke, the piston begins moving up from BDC and expels the byproducts of combustion through an exhaust valve 130. The byproducts of combustion are exhausted from the vehicle via an exhaust system 134.

The intake valve 122 may be controlled by an intake camshaft 140, while the exhaust valve 130 may be controlled by an exhaust camshaft 142. In various implementations, multiple intake camshafts (including the intake camshaft 140) may control multiple intake valves (including the intake valve 122) for the cylinder 118 and/or may control the intake valves (including the intake valve 122) of multiple banks of cylinders (including the cylinder 118). Similarly, multiple exhaust camshafts (including the exhaust camshaft 142) may control multiple exhaust valves for the cylinder 118 and/or may control exhaust valves (including the exhaust valve 130) for multiple banks of cylinders (including the cylinder 118). While camshaft based valve actuation is shown and has been discussed, camless valve actuators may be implemented. While separate intake and exhaust camshafts are shown, one camshaft having lobes for both the intake and exhaust valves may be used.

The cylinder actuator module 120 may deactivate the cylinder 118 by disabling opening of the intake valve 122 and/or the exhaust valve 130. The time when the intake valve 122 is opened may be varied with respect to piston TDC by an intake cam phaser 148. The time when the exhaust valve 130 is opened may be varied with respect to piston TDC by an exhaust cam phaser 150. A phaser actuator module 158 may control the intake cam phaser 148 and the exhaust cam phaser 150 based on signals from the ECM 114. In various implementations, cam phasing may be omitted. Variable valve lift (not shown) may also be controlled by the phaser actuator module 158. In various other implementations, the intake valve 122 and/or the exhaust valve 130 may be controlled by actuators other than a camshaft, such as electromechanical actuators, electrohydraulic actuators, electromagnetic actuators, etc.

The engine 102 may include zero, one, or more than one boost device that provides pressurized air to the intake manifold 110. For example, FIG. 1 shows a turbocharger including a turbocharger turbine 160-1 that is driven by exhaust gases flowing through the exhaust system 134. A supercharger is another type of boost device.

The turbocharger also includes a turbocharger compressor 160-2 that is driven by the turbocharger turbine 160-1 and that compresses air leading into the throttle valve 112. A wastegate 162 controls exhaust flow through and bypassing the turbocharger turbine 160-1. Wastegates can also be referred to as (turbocharger) turbine bypass valves. The wastegate 162 may allow exhaust to bypass the turbocharger turbine 160-1 to reduce intake air compression provided by the turbocharger. The ECM 114 may control the turbocharger via a wastegate actuator module 164. The wastegate actuator module 164 may modulate the boost of the turbocharger by controlling an opening of the wastegate 162.

A cooler (e.g., a charge air cooler or an intercooler) may dissipate some of the heat contained in the compressed air charge, which may be generated as the air is compressed. Although shown separated for purposes of illustration, the turbocharger turbine 160-1 and the turbocharger compressor 160-2 may be mechanically linked to each other, placing intake air in close proximity to hot exhaust. The compressed air charge may absorb heat from components of the exhaust system 134.

The engine 102 may include an exhaust gas recirculation (EGR) valve 170, which selectively redirects exhaust gas back to the intake manifold 110. The EGR valve 170 may receive exhaust gas from upstream of the turbocharger turbine 160-1 in the exhaust system 134. The EGR valve 170 may be controlled by an EGR actuator module 172.

Crankshaft position may be measured using a crankshaft position sensor 180. An engine speed may be determined based on the crankshaft position measured using the crankshaft position sensor 180. A temperature of engine coolant may be measured using an engine coolant temperature (ECT) sensor 182. The ECT sensor 182 may be located within the engine 102 or at other locations where the coolant is circulated, such as a radiator (not shown).

A pressure within the intake manifold 110 may be measured using a manifold absolute pressure (MAP) sensor 184. In various implementations, engine vacuum, which is the difference between ambient air pressure and the pressure within the intake manifold 110, may be measured. A mass flow rate of air flowing into the intake manifold 110 may be measured using a mass air flow (MAF) sensor 186. In various implementations, the MAF sensor 186 may be located in a housing that also includes the throttle valve 112.

Position of the throttle valve 112 may be measured using one or more throttle position sensors (TPS) 190. A temperature of air being drawn into the engine 102 may be measured using an intake air temperature (IAT) sensor 192.

One or more other sensors 193 may also be implemented. For example, an exhaust temperature sensor may measure a temperature of exhaust within an exhaust manifold that receives exhaust gas output from the cylinders. The other sensors 193 include an accelerator pedal position (APP) sensor, a brake pedal position (BPP) sensor, may include a clutch pedal position (CPP) sensor (e.g., in the case of a manual transmission), and may include one or more other types of sensors. An APP sensor measures a position of an accelerator pedal within a passenger cabin of the vehicle. A BPP sensor measures a position of a brake pedal within a passenger cabin of the vehicle. A CPP sensor measures a position of a clutch pedal within the passenger cabin of the vehicle. The ECM 114 may use signals from the sensors to make control decisions for the engine 102.

The ECM 114 may communicate with a transmission control module 194, for example, to coordinate engine operation with gear shifts in a transmission 195. The ECM 114 may communicate with a hybrid control module 196, for example, to coordinate operation of the engine 102 and a motor generator unit (MGU) 198. While the example of one MGU is provided, multiple MGUs and/or electric motors may be implemented. The terms MGU and electric motor may be interchangeable herein. In various implementations, various functions of the ECM 114, the transmission control module 194, and the hybrid control module 196 may be integrated into one or more modules.

Each system of the engine 102 that varies an engine parameter may be referred to as an engine actuator. Each engine actuator has an associated actuator value. For example, the throttle actuator module 116 may be referred to as an engine actuator, and the throttle opening area may be referred to as the actuator value. In the example of FIG. 1, the throttle actuator module 116 achieves the throttle opening area by adjusting an angle of the blade of the throttle valve 112.

The spark actuator module 126 may also be referred to as an engine actuator, while the corresponding actuator value may be the amount of spark advance relative to cylinder TDC. Other engine actuators may include the cylinder actuator module 120, the fuel actuator module 124, the phaser actuator module 158, the wastegate actuator module 164, and the EGR actuator module 172. For these engine actuators, the actuator values may correspond to a cylinder activation/deactivation sequence, fueling rate, intake and exhaust cam phaser angles, target wastegate opening, and EGR valve opening, respectively.

The ECM 114 may control the actuator values in order to cause the engine 102 to output torque based on a torque request. The ECM 114 may determine the torque request, for example, based on one or more driver inputs, such as an APP, a BPP, a CPP, and/or one or more other suitable inputs. The ECM 114 may determine the torque request, for example, using one or more functions or lookup tables that relate the input(s) to torque requests.

Under some circumstances, the hybrid control module 196 controls the MGU 198 to output torque, for example, to supplement engine torque output. The hybrid control module 196 applies electrical power from a battery 199 to the MGU 198 to cause the MGU 198 to output positive torque. While the example of the battery 199 is provided, more than one battery may be used to supply power to the MGU 198. The MGU 198 may output torque, for example, to the engine 102, to an input shaft of the transmission 195, to an output shaft of the transmission 195, or to another torque transfer device of the powertrain of the vehicle. The battery 199 may be dedicated for the MGU 198 and one or more other batteries may supply power for other vehicle functions.

Under other circumstances, the hybrid control module 196 may control the MGU 198 to convert mechanical energy of the vehicle into electrical energy. The hybrid control module 196 may control the MGU 198 to convert mechanical energy into electrical energy, for example, to recharge the battery 199. This may be referred to as regeneration.

The vehicle also includes an audio control module 200 that controls sound output via speakers 204. The speakers 204 may be located and output sound to within the passenger cabin of the vehicle. However, one or more of the speakers 204 may be implemented at another location, such as in the exhaust system 134. The audio control module 200 may control the speakers 204 to output sound based on received amplitude modulation (AM) signals, received frequency modulation (FM) signals, received satellite signals, and other types of audio signals. The audio control module 200 may be implemented, for example, with an infotainment system.

Under some circumstances, the audio control module 200 additionally or alternatively control the sound output via the speakers 204 to generate engine sound. The audio control module 200 may generate engine sound via the speakers 204, for example, to enhance and/or cancel various components of sound output by the engine 102.

The audio control module 200 may receive parameters from the ECM 114, the hybrid control module 196, the transmission control module 194, and/or one or more other control modules of the vehicle. The audio control module 200 may receive parameters from other modules, for example, via a car area network (CAN) bus or another type of network.

As discussed further below, the audio control module 200 selectively adjusts engine sound output when the driver of the vehicle is wearing a helmet. The audio control module 200 may, for example, adjust engine sound output based on a (sound) transfer function of the specific type of helmet that the driver is wearing. One or more passenger cabin sensors 206 indicate or can be used to determine whether the driver is wearing a helmet and, if so, the type of the helmet.

For example, the one or more passenger cabin sensors 206 may include a driver facing camera that captures images of a predetermined area occupied by the driver including the driver's head. The driver facing camera faces the driver's seat of the vehicle. Whether the driver is wearing a helmet and a type of the helmet can be determined based on whether one or more images captured by the driver facing camera include an object having the shape of a helmet. Additionally or alternatively, the one or more passenger cabin sensors 206 may include one or more sensors (e.g., radar, light detection and ranging (LIDAR), sonar) that transmit signals in the predetermined area occupied by the driver including the driver's head and receive signals reflected by objects within the predetermined area. These sensors also face the driver's seat of the vehicle. Whether the driver is wearing a helmet and a type of the helmet can be determined based on whether the received signals correspond to the driver wearing an object having the shape of a helmet. Additionally or alternatively, the one or more passenger cabin sensors 206 may include one or more sensors (e.g., radio frequency identification, RFID) that generate signals (e.g., an electromagnetic field) in a predetermined area where a helmet of the driver would be located and that receive signals from devices (e.g., active or passive RFID tags) within the predetermined area. For example, an RFID transceiver may be implemented within a headrest of a driver seat of the vehicle. Whether the driver is wearing a helmet and a type of the helmet can be determined based on received signals.

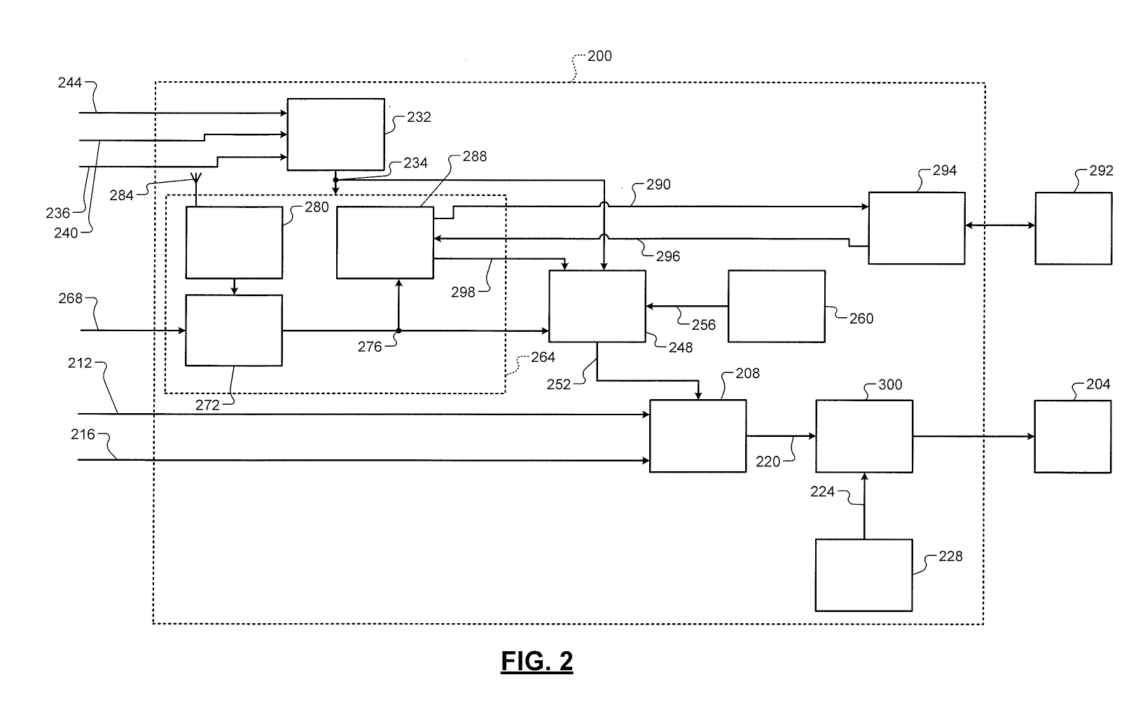

FIG. 2 is a functional block diagram of an example audio system including the audio control module 200 and the speakers 204. The speakers 204 output sound within the passenger cabin of the vehicle and/or at one or more other locations of the vehicle, such as at the exhaust system 134 of the vehicle.

A sound control module 208 determines how to output sound via the speakers 204 based on at least one of an engine speed 212 and an engine torque 216. More specifically, the sound control module 208 sets characteristics 220 of one or more predetermined sounds 224 to output via the speakers 204 based on at least one of the engine speed 212 and the engine torque 216.

The engine speed 212 may be measured using an engine speed sensor or determined (e.g., by an engine speed module of the ECM 114) based on changes in crankshaft position measured using the crankshaft position sensor 180 over a period between crankshaft positions. The engine torque 216 may be measured using a torque sensor or determined (e.g., by a torque estimation module of the ECM 114) based on one or more parameters using one or more equations and/or lookup tables that relate the parameter(s) to engine torque. As an example, the torque estimation module may determine the engine torque 216 using a torque relationship such as

T=f(APC,S,I,E,AF,OT,#),

where torque (T) is a function of air per cylinder (APC), spark advance (S), intake cam phaser position (I), exhaust cam phaser position (E), air/fuel ratio (AF), oil temperature (OT), and number of activated cylinders (#). Additional variables may also be accounted for, such as the degree of opening of an exhaust gas recirculation (EGR) valve. This relationship may be modeled by an equation and/or may be stored as a lookup table. The torque estimation module may determine the APC based on measured MAF and the engine speed 212, for example, using one or more equations and/or lookup tables that relate MAF and engine speed to APC.

The predetermined sounds 224 may include one or more predetermined sounds (or tones) to be output at predetermined harmonics of a frequency (e.g., the predetermined fundamental frequency (e.g., in Hertz) of the engine 102, a frequency corresponding to the engine speed 212, or a frequency not corresponding to the engine speed 212).

Predetermined sounds output at harmonics of frequencies not corresponding to the engine speed 212 may be output, for example, to cancel and/or attenuate various sounds and/or for one or more other purposes. Predetermined sounds output at or based on harmonics of frequencies corresponding to the engine speed 212 may be output, for example, to enhance or attenuate sound at those harmonics. Predetermined sounds output at or based on harmonics of the predetermined fundamental frequency of the engine 102 may be output, for example, to enhance or attenuate sound at those harmonics.

The characteristics 220 at a given time may include, for example, magnitudes (e.g., in dB) for each of the predetermined harmonics, respectively, of a base frequency (e.g., the predetermined fundamental frequency, a frequency corresponding to the engine speed 212, or a frequency not corresponding to the engine speed 212) at which to output a given one of the predetermined sounds 224. While the example of one of the predetermined sounds will be discussed, the characteristics 220 may include the same information for multiple different predetermined sounds. Also, while the example of one base frequency will be discussed, the characteristics 220 may include the same information for multiple different base frequencies. The predetermined harmonics may include, for example but not limited to, 0.5, 1, 1.5, 2, 2.5, 3, 3.5, 4, 4.5, 5, 5.5, 6, 6.5, 7, 7.5, and 8^{th} harmonics of the base frequency. The predetermined harmonics, however, may include one or more other harmonics. Sound files of the predetermined sound(s) 224 (or tones) are stored in memory, such as in sound memory 228.

The sound control module 208 determines base magnitudes for outputting the one of the predetermined sounds 224 at the predetermined harmonics of the base frequency based on the engine torque 216. For example, the sound control module 208 determines the base magnitudes for outputting the one of the predetermined sounds 224 using a lookup table of base magnitudes for outputting the one of the predetermined sounds 224 at the predetermined harmonics indexed by engine torque. An example of one row of such a lookup table for one engine torque is provided below merely as an illustrative aid.

| | | | | | | | | | |
|---|---|---|---|---|---|---|---|---|---|
| H−> | 0.5 | 1.0 | 1.5 | 2.0 | 2.5 | 3.0 | 3.5 | 4.0 | . . . |
| T | | | | | | | | | |
| \| | | | | | | | | | |
| V | | | | | | | | | |
| T | BM0.5 | BM1 | BM1.5 | BM2 | BM2.5 | BM3 | BM3.5 | BM4 | . . . |

The top row lists predetermined harmonics (H) of the base frequency (e.g., the predetermined fundamental frequency of the engine 102, a frequency corresponding to the engine speed 212, or a frequency not corresponding to the engine speed 212). For example, 0.5 corresponds to the 0.5th harmonic of the base frequency, 1.0 corresponds to the first harmonic of the base frequency, and so on. The bottom row lists, for the engine torque T, base magnitudes (BM) for the predetermined harmonics, respectively, at which to output the one of the predetermined sounds 224. For example, BM0.5 corresponds to the base magnitude for the 0.5th harmonic of the base frequency, BM1 corresponds to the base magnitude for the first harmonic of the base frequency, and so on.

The lookup table may be calibrated based on the driver not wearing a helmet. However, the driver may wear a helmet under some circumstances, such as during track driving. While the example of the lookup table being calibrated based on the driver not wearing a helmet is discussed, the lookup table may be calibrated based on the driver wearing a helmet or a mixture suitable for both drivers wearing helmets and drivers not wearing helmets.

When the driver is wearing a helmet, the sound control module 208 may increase one or more of the base magnitudes for the one of the predetermined sounds 224 at one or more of the predetermined harmonics, respectively. Additionally or alternatively, when the driver is wearing a helmet, the sound control module 208 may decrease one or more of the base magnitudes for the one of the predetermined sounds 224 at one or more of the predetermined harmonics, respectively. Additionally or alternatively, when the driver is wearing a helmet, the sound control module 208 may decrease one or more of the base magnitudes for the one of the predetermined sounds 224 at one or more of the predetermined harmonics, respectively, to zero. The one of the predetermined sounds 224 will not be output at the predetermined harmonic when the magnitude for the predetermined harmonic is set to zero. The one of the predetermined sounds 224 may be output to perform sound cancellation at the predetermined harmonic when the magnitude for the predetermined harmonic is a negative value.

A track module 232 determines whether the vehicle is in a track mode. The track module 232 indicates whether the vehicle is in the track mode via a track signal 234. For example, the track module 232 may set the track signal 234 to a first state when the vehicle is not in the track mode and set the track signal 234 to a second state when the vehicle is in the track mode.

The track module 232 may determine whether the vehicle is in the track mode based on a driver selected mode 236. At a given time, the driver selected mode 236 may be, for example, one of sport, economy, or another suitable mode. The track module 232 may determine that the vehicle is in the track mode when the driver selected mode 236 is sport.

The track module 232 may determine whether the vehicle is in the track mode additionally or alternatively based on one or more other parameters, such as a vehicle speed (VS) 240 and a lateral acceleration 244 of the vehicle. For example, the track module 232 may increment a counter value when both the vehicle speed 240 is greater than a predetermined speed and the lateral acceleration 244 (e.g., a magnitude) is greater than a predetermined acceleration. The track module 232 may decrement the counter value when at least one of the vehicle speed 240 is less than the predetermined speed and the lateral acceleration 244 is less than the predetermined acceleration.

The track module 232 may set the track signal 234 to the second state when the counter value is greater than a predetermined value that is greater than zero. When the counter value is less than the predetermined value, the track module 232 may set the track signal 234 to the first state. The vehicle speed 312 may be determined, for example, based on an average of one or more wheel speeds of the vehicle. Wheel speeds may be measured using wheel speed sensors. The lateral acceleration 316 may be, for example, measured using a lateral acceleration sensor. Further information regarding determining whether the vehicle is being driven on a track (e.g., the second state) or not (e.g., the first state) may be found in commonly assigned U.S. Pat. No. 6,408,229, which is incorporated herein in its entirety.

The track module 232 may determine whether the vehicle is in the track mode additionally or alternatively based on whether a location of the vehicle is within a predetermined locational boundaries of a track. Predetermined locational boundaries (e.g., coordinates) of tracks may be stored in a track database. The track module may determine that the vehicle is in track mode when the location of the vehicle is within the predetermined locational boundaries of a track. The location of the vehicle may be determined, for example, using a global positioning system (GPS) or another type of satellite based location system.

When the track signal 234 is in the second state (i.e., when the vehicle is in the track mode), an adjustment module 248 determines magnitude adjustments 252 for the predetermined harmonics, respectively, of the base frequency. The adjustment module 248 sets each of the magnitude adjustments 252 to a predetermined non-adjusting value when the track signal is in the first state (i.e., when the vehicle is not in the track mode). When the magnitude adjustments 252 are set to the predetermined non-adjusting value, the one of the predetermined sounds 224 will be output according to the base magnitudes.

When the track signal 234 is in the second state, the adjustment module 248 determines the magnitude adjustments 252 based on whether the driver is wearing a helmet and, if so, a type of the helmet. More specifically, when the driver is wearing a helmet, the adjustment module 248 determines helmet magnitude adjustments 256 for the predetermined harmonics, respectively, based on the type of the helmet and sets the magnitude adjustments 252 to the helmet magnitude adjustments 256, respectively.

For example, the adjustment module 248 may determine the helmet magnitude adjustments 256 using a helmet database 260 including sets of helmet magnitude adjustments for different types of helmets, respectively. An example of one row of such a helmet database for one type of helmet is provided below merely as an illustrative aid.

| | | | | | | | | | |
|---|---|---|---|---|---|---|---|---|---|
| H−> | 0.5 | 1.0 | 1.5 | 2.0 | 2.5 | 3.0 | 3.5 | 4.0 | . . . |
| Type | | | | | | | | | |
| \| | | | | | | | | | |
| V | | | | | | | | | |
| | MA0.5 | MA1 | MA1.5 | MA2 | MA2.5 | MA3 | MA3.5 | MA4 | . . . |

The top row lists predetermined harmonics (H) of the base frequency (e.g., the predetermined fundamental frequency of the engine 102, a frequency corresponding to the engine speed 212, or a frequency not corresponding to the engine speed 212). For example, 0.5 corresponds to the 0.5th harmonic of the base frequency, 1.0 corresponds to the first harmonic of the base frequency, and so on. The bottom row lists, for the type of the helmet, helmet magnitude adjustments (MA) for the predetermined harmonics, respectively, at which to output the one of the predetermined sounds 224. For example, MA0.5 corresponds to the helmet magnitude adjustment for the 0.5th harmonic of the base frequency, MA1 corresponds to the helmet magnitude adjustment for the first harmonic of the base frequency, and so on. The helmet magnitude adjustments may be calibrated for different types of helmets such that the driver experiences the same or similar sound for each of the different type of helmet as when the driver is not wearing a helmet.

In various implementations, the adjustment module 248 may determine a (acoustic) transfer function based on the type of the helmet. The adjustment module 248 may determine the transfer function from a database of transfer functions indexed by type of helmet. The adjustment module 248 may determine the helmet magnitude adjustments 256 based on the transfer function for the type of the helmet. For example, the adjustment module 248 may determine the helmet magnitude adjustments 256 using at least one of a database and a function that relates transfer functions to helmet magnitude adjustments.

In various implementations, the type of helmet may be selected from a group consisting of: an open face helmet and a closed faced helmet. In various implementations, the type of helmet may be more specific than open face or closed face. For example, the type of helmet may include a specific model of helmet.

When the track signal 234 is set to the second state, a helmet identification module 264 determines whether the driver is wearing a helmet and, if so, the type of the helmet. The helmet identification module 264 determines whether the driver is wearing a helmet and the type of the helmet based on cabin signals 268 from the one or more passenger cabin sensors 206.

For example, in the example of the inclusion of a driver facing camera, a helmet module 272 may determine whether one or more images including a head of the driver captured using the driver facing camera include a shape corresponding to one or more predetermined shapes of helmet. For example, the helmet module 272 may determine whether one or more images include a shape corresponding to a predetermined shape of a closed face helmet or a predetermined shape of an open face helmet. In various implementations, the helmet module 272 may also determine a model or brand of the helmet based on one or more visual features of the helmet included in the one or more images. Examples of visual features include, for example, exterior graphics (e.g., art, logo, etc.), shape, size, and locations of one or more components of the helmet. The helmet module 272 indicates whether the driver is wearing a helmet and, if so, a type of the helmet via a helmet signal 276. In various implementations, a driver facing camera may determine whether a driver is wearing a helmet and the type of the helmet and generate a signal accordingly.

In another example, a transceiver module 280 wirelessly transmits signals in the passenger cabin via one or more antennas, such as antenna 284. Examples of the signals include, for example, radar signals, sonar signals, LIDAR signals, and RFID signals. The transceiver module 280 transmits received signals to the helmet module 272. The helmet module 272 may determine whether signals received are indicative of a shape corresponding to one or more predetermined shapes of helmet. For example, the helmet module 272 may determine whether the received signals are indicative of a shape corresponding to a predetermined shape of a closed face helmet or a predetermined shape of an open face helmet. In the example of RFID, the helmet module 272 may determine whether the received signals are indicative of the presence of an RFID tag. In this example, the received signals may also indicate the type of the helmet. RFID tags may be adhered to or imbedded in helmets, for example, in the rear bottom portion of helmets for communication with RFID transceivers in a head rest of the driver's seat. The helmet module 272 indicates whether the driver is wearing a helmet and, if so, a type of the helmet via the helmet signal 276. In various implementations, the transceiver module 280 may include two or more different types of transceivers, such as an RFID transceiver and at least one of a radar, sonar, and LIDAR transceiver.

In various implementations, a profile module 288 may indicate whether the driver is wearing a helmet and the type of the helmet. For example, the profile module 288 may selectively generate a request 290 to display an option on a touchscreen display 292 within the passenger cabin to input information regarding whether the driver wears a helmet while operating in the track mode and, if so, a type of the helmet. In response to the request 290, a display input/output (I/O) module 294 displays the option on the touchscreen display 292.

The driver can input whether the driver will wear a helmet during operation in the track mode via touching the touchscreen display 292 and/or actuation of one or more other user input devices (e.g., buttons, switches, knobs, etc.). The display I/O module 294 may display predetermined types of helmets on the touchscreen display 292 in response to receipt of user input that the driver will wear a helmet during operation in the track mode. The display I/O module 294 transmits profile data 296 to the profile module 288 based on user input. The profile data 296 includes, for example, an indicator of whether the driver will wear a helmet during operation in the track mode and the type of the helmet.

In various implementations, the profile module 288 may receive indicators of whether the driver will wear a helmet during operation in the track mode and the type of the helmet wirelessly via one or more antennas, such as via a satellite communication network or a cellular communication network. A user associated with the vehicle may input indicators of whether the driver will wear a helmet during operation in the track mode and the type of the helmet via a mobile electronic device that is separate from the vehicle, such as a cellular phone or a tablet device. The profile module 288 indicates whether the driver is wearing a helmet and, if so, a type of the helmet via a helmet signal 298. The adjustment module 248 may determine whether the driver is wearing a helmet and the type of the helmet based on at least one of the helmet signal 276 and the helmet signal 298. In various implementations, the profile module 288 may store the helmet type determined by the helmet module 272.

As discussed above, the sound control module 208 determines the base magnitudes for the respective predetermined harmonics of the base frequency based on the engine torque 216. When the driver is wearing a helmet, during operation in the track mode, the sound control module 208 adjusts the base magnitudes for the predetermined harmonics based on the helmet magnitude adjustments 256 for the predetermined harmonics, respectively.

For example, the sound control module 208 may set adjusted magnitudes for the predetermined harmonics based on or equal to the base magnitudes plus the magnitude adjustments, respectively. As an example, the sound control module 208 may set the adjusted magnitude for the 0.5th harmonic of the base frequency based on or equal to the base magnitude determined for the 0.5th harmonic of the base frequency (based on the engine torque 216) plus the magnitude adjustment determined for the 0.5th harmonic of the base frequency (based on the helmet of the driver). This is performed similarly to determine the adjusted magnitude for each of the predetermined harmonics. In various implementations, subtraction, multiplication, or another function may be used. The sound control module 208 includes the adjusted magnitudes for the predetermined harmonics, respectively, in the characteristics 220 for the one of the predetermined sounds 224.

An audio driver module 300 receives the characteristics 220 and the predetermined sound(s) 224. The audio driver module 300 applies power (e.g., from the one or more other batteries) to the speakers 204 to output the one of the predetermined sounds 224 at the respective frequencies (corresponding to the predetermined harmonics of the base frequency) and adjusted magnitudes specified by in the characteristics 220. As discussed above, the adjusted magnitudes for the predetermined harmonics, respectively, of the base frequency are set based on use of a helmet by the driver.

Adjusting the magnitudes of the sound output based on helmet use of the driver provides more consistent aural experience regardless of whether the driver is wearing a helmet or not and for different types of helmets. In other words, by adjusting the base magnitudes for use of a helmet, the sound control module 208 provides the driver with an aural experience that is the same or similar to that which the driver would experience if the driver was not wearing the helmet and if the driver was wearing a different type of helmet. This may improve the aural experience of drivers using helmets. If the base magnitudes are calibrated to be suitable for both drivers wearing helmets and drivers not wearing helmets, adjusting the base magnitudes based on helmet use may improve the aural experience of both drivers using helmets and drivers not using helmets.

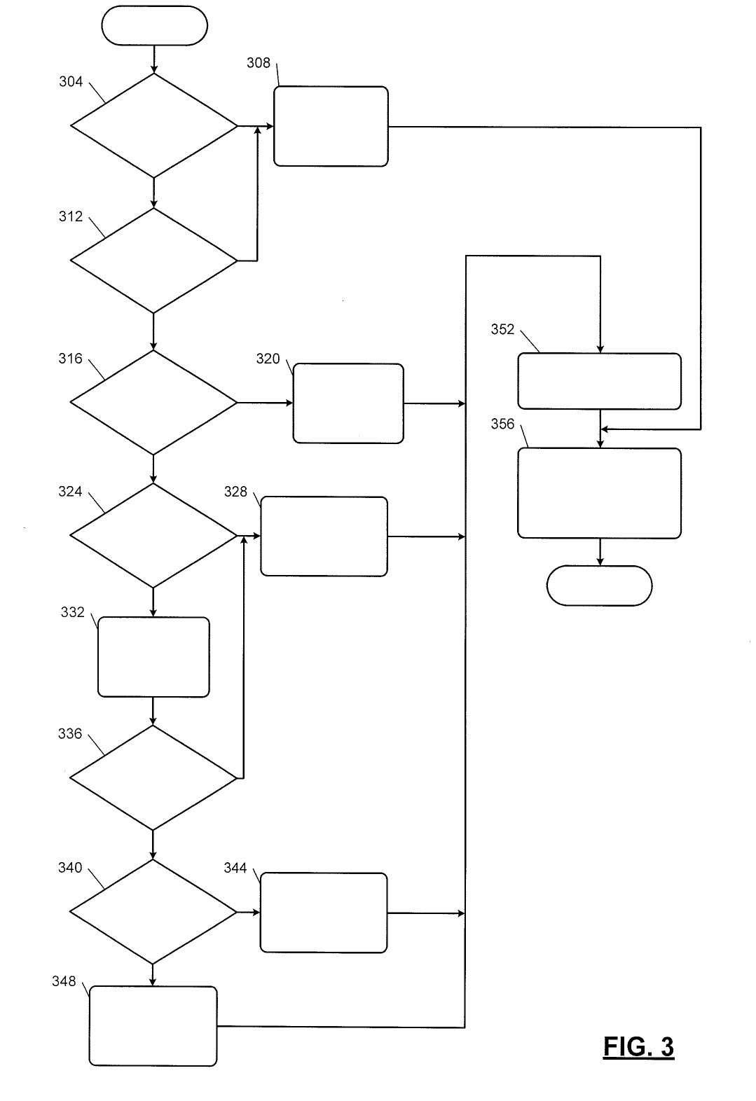

FIG. 3 is a flowchart depicting an example method of controlling sound output based on a helmet used by the driver. Control may begin with 304 where the track module 232 determines whether the vehicle is in the track mode or not, as discussed above. If 304 is true, the track module 232 sets the track signal 234 to the second state, and control continues with 312. If 304 is false, the track module 232 sets the track signal 234 to the first state, and control transfers to 308. At 308, based on the track signal 234 being in the first state, the adjustment module 248 sets the magnitude adjustments 252 to the predetermined non-adjusting values. For example, the predetermined non-adjusting values may be 0 in the example of summing the base magnitudes with the magnitude adjustments 252, respectively. Based on the magnitude adjustments 252 being set to the predetermined non-adjusting values, the sound control module 208 sets the adjusted magnitudes equal to the base magnitudes, respectively. Control continues with 356, which is discussed further below.

At 312, the adjustment module 248 may determine whether the driver is wearing a helmet. The adjustment module 248 may determine whether the driver is wearing a helmet based on whether one or more of the helmet signals 276 and 298 indicate that the driver is wearing a helmet. If 312 is false, control transfers to 308, as discussed above. If 312 is true, control continues with 316.

At 316, the adjustment module 248 determines whether the specific type (e.g., model/make) of the helmet of the driver has been determined. This is more specific than whether the helmet is open faced or closed face. For example, the helmet module 272 may determine the type of the helmet based on one or more images captured by the driver facing camera and/or the helmet module 272 may determine the type of the helmet based on received signals (e.g., from or altered by an RFID tag). If 316 is true, the adjustment module 248 determines the helmet magnitude adjustments 256 for the specific type of the helmet from the helmet database 260 at 320. The adjustment module 248 sets the magnitude adjustments 252 to the helmet magnitude adjustments 256. Control continues with 352, which is discussed further below. If 316 is false, control continues with 324.

At 324, the adjustment module 248 may determine whether the specific type of the helmet of the driver has been previously input by the driver and stored. For example, the profile module 288 may have previously stored the type of helmet of the driver in response to user input (e.g., selection of one of the predetermined types of helmets) from the touchscreen display 292 or another device, such as a cellular phone or a tablet. If 324 is true, the adjustment module 248 determines the helmet magnitude adjustments 256 for the specific type of the helmet from the helmet database 260 at 328. The adjustment module 248 may determine the helmet magnitude adjustments 256 further based on earplug use of the driver if the driver additionally input that the driver uses ear plugs during track mode operation at 328. The adjustment module 248 sets the magnitude adjustments 252 to the helmet magnitude adjustments 256. Control continues with 352, which is discussed further below. If 324 is false, control continues with 332.

At 332, the profile module 288 generates the request 290 to display the option to input whether the driver uses a helmet and, if so, the helmet type of the driver. The driver may also be able to input whether the driver uses ear plugs or not. The display I/O module 294 displays the information on the touchscreen display 292 at 332 based on the request 290.

At 336, the profile module 288 determines whether user input has been received indicating whether the driver wears a helmet and, if so, the helmet type of the driver. If 336 is true, control transfers to 328, as discussed above. If 336 is false, control continues with 340. In various implementations, the display I/O module 294 may remove the display when no user input is received for a predetermined period or user input indicating that the driver does not want to input helmet information.

At 340, the adjustment module 248 determines whether the helmet being worn by the driver is an open faced helmet. If 340 is true, the adjustment module 248 determines the helmet magnitude adjustments 256 for an open faced type helmet from the helmet database 260 at 344, and control continues with 352. If 340 is false, the helmet is a closed face helmet, and the adjustment module 248 determines the helmet magnitude adjustments 256 for a closed faced type helmet from the helmet database 260 at 348. Control continues with 352.

At 352, the sound control module 208 adjusts the base magnitudes for the predetermined harmonics, respectively, based on the magnitude adjustments 252 for the predetermined harmonics, respectively. For example, the sound control module 208 may add the base magnitudes for the predetermined harmonics with the magnitude adjustments 252 for the predetermined harmonics, respectively. As an example, the sound control module 208 may set the adjusted magnitude for the 0.5th harmonic of the base frequency based on or equal to the base magnitude determined for the 0.5th harmonic of the base frequency plus the magnitude adjustment determined for the 0.5th harmonic of the base frequency.

At 356, the audio driver module 300 applies electrical power to the speakers 204 to output the one of the predetermined sounds 224 at the frequencies (i.e., the frequencies of the predetermined harmonic of the base frequency) and the adjusted magnitudes for the predetermined harmonics, respectively. The one of the predetermined sounds 224 is therefore output via the speakers 204 at the frequencies and adjusted magnitudes, respectively.

While the example of FIG. 3 is shown as ending, FIG. 3 is illustrative of one control loop and control loops may be initiated at a predetermined rate. Also, FIG. 3 may be performed for more than one of the predetermined sounds 224 to be output and/or for predetermined harmonics of more than one base frequency.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

What is claimed is:

1. An audio control system of a vehicle, comprising:
a sound control module configured to determine N magnitudes for outputting a predetermined sound at N predetermined harmonics of a base frequency, respectively, wherein N is an integer greater than one; and
an adjustment module configured to determine N magnitude adjustments for the N predetermined harmonics, respectively, based on a helmet worn by a driver of the vehicle;
wherein the sound control module is further configured to determine N adjusted magnitudes for the N predetermined harmonics based on:
the N magnitudes for the N predetermined harmonics, respectively; and
the N magnitude adjustments for the N predetermined harmonics, respectively; and
an audio driver module configured to, based on the N adjusted magnitudes, apply power to at least one speaker of the vehicle and output the predetermined sound at the N predetermined harmonics of the base frequency, respectively.

2. The audio control system of claim 1 wherein the adjustment module is configured to:
when the helmet worn by the driver is a closed faced helmet, set the N magnitude adjustments for the N predetermined harmonics to a first set of N predetermined magnitude adjustments for the N predetermined harmonics calibrated for closed faced helmets; and
when the helmet worn by the driver is an open faced helmet, set the N magnitude adjustments for the N predetermined harmonics to a first set of N predetermined magnitude adjustments for the N predetermined harmonics calibrated for open faced helmets.

3. The audio control system of claim 2 further comprising a helmet module configured to, based on images captured using a driver facing camera within a passenger cabin of the vehicle, indicate that the helmet worn by the driver is one of:
an open face helmet and a closed face helmet.

4. The audio control system of claim 1 further comprising a track module configured to indicate whether the vehicle is in a track mode; and
wherein the adjustment module is configured to determine the N magnitude adjustments based on the helmet worn by the driver when the vehicle is in the track mode.

5. The audio control system of claim 4 wherein the adjustment module is configured to set the N magnitude adjustments to a predetermined value when the vehicle is not in the track mode,
wherein, based on the N magnitude adjustments being set to the predetermined value, the sound control module is configured to set the N adjusted magnitudes for the N predetermined harmonics equal to the N magnitudes for the N predetermined harmonics, respectively.

6. The audio control system of claim 4 wherein the track module is configured to determine whether the vehicle is in the track mode based on a vehicle speed and a lateral acceleration of the vehicle.

7. The audio control system of claim 4 wherein the adjustment module is configured to set the N magnitude adjustments to a predetermined value when the driver is not wearing a helmet,
wherein, based on the N magnitude adjustments being set to the predetermined value, the sound control module is configured to set the N adjusted magnitudes for the N predetermined harmonics equal to the N magnitudes for the N predetermined harmonics, respectively.

8. The audio control system of claim 1 wherein the sound control module is configured to determine the N magnitudes based on a torque output of an engine of the vehicle.

9. The audio control system of claim 1 wherein the adjustment module is configured to:
when the helmet worn by the driver is a first type of helmet, set the N magnitude adjustments for the N predetermined harmonics to a first set of N predetermined magnitude adjustments for the N predetermined harmonics calibrated for the first type of helmet; and
when the helmet worn by the driver is a second type of helmet, set the N magnitude adjustments for the N predetermined harmonics to a first set of N predetermined magnitude adjustments for the N predetermined harmonics calibrated for the second type of helmet.

10. The audio control system of claim 9 wherein:
the first type of helmet is a first model of helmet; and
the second type of helmet is a second model of helmet.

11. The audio control system of claim 9 further comprising a helmet module configured to indicate a type of the helmet worn by the driver based on at least one image captured using a driver facing camera within a passenger cabin of the vehicle.

12. The audio control system of claim 9 further comprising a helmet module configured to indicate a type of the helmet worn by the driver based on signals from at least one of:
a radar sensor within a passenger cabin of the vehicle;
a sonar sensor within the passenger cabin of the vehicle;
a light detection and ranging (LIDAR) sensor within the passenger cabin of the vehicle; and
a radio frequency identification (RFID) transceiver within the passenger cabin of the vehicle.

13. The audio control system of claim 9 further comprising a profile module configured to indicate a type of the helmet worn by the driver based on user input signals indicative of the type of helmet worn by the driver.

14. The audio control system of claim 1 wherein the sound control module is configured to set the N adjusted magnitudes for the N predetermined harmonics based on sums of:
the N magnitudes for the N predetermined harmonics, respectively; and
the N magnitude adjustments for the N predetermined harmonics, respectively.

15. The audio control system of claim 1 wherein the sound control module is configured to set the N adjusted magnitudes for the N predetermined harmonics based on mathematical products of:
the N magnitudes for the N predetermined harmonics, respectively; and
the N magnitude adjustments for the N predetermined harmonics, respectively.

16. The audio control system of claim 1 wherein the base frequency is a predetermined fundamental frequency of an engine.

17. The audio control system of claim 1 wherein the base frequency corresponds to a rotational speed of an engine.

18. The audio control system of claim 1 wherein the base frequency does not correspond to a rotational speed of an engine and is not a predetermined fundamental frequency of the engine.

19. An audio control method for a vehicle, comprising:
determining N magnitudes for outputting a predetermined sound at N predetermined harmonics of a base frequency, respectively, wherein N is an integer greater than one;
determining N magnitude adjustments for the N predetermined harmonics, respectively, based on a helmet worn by a driver of the vehicle;
determining N adjusted magnitudes for the N predetermined harmonics based on:
the N magnitudes for the N predetermined harmonics, respectively; and
the N magnitude adjustments for the N predetermined harmonics, respectively; and
based on the N adjusted magnitudes, applying power to at least one speaker of the vehicle and outputting the predetermined sound at the N predetermined harmonics of the base frequency, respectively.

20. The audio control method of claim 19 wherein determining the N magnitude adjustments for the N predetermined harmonics, respectively, includes:
when the helmet worn by the driver is a first type of helmet, setting the N magnitude adjustments for the N predetermined harmonics to a first set of N predetermined magnitude adjustments for the N predetermined harmonics calibrated for the first type of helmet; and
when the helmet worn by the driver is a second type of helmet, setting the N magnitude adjustments for the N predetermined harmonics to a first set of N predetermined magnitude adjustments for the N predetermined harmonics calibrated for the second type of helmet.
